(19) United States
(12) Patent Application Publication
(10) Pub. No.: US 2008/0046466 A1
(43) Pub. Date: Feb. 21, 2008

(54) Service Method and System of Multimedia Music Contents

(75) Inventor: Shinsoo Yun, Seoul (KR)

Correspondence Address: HARNESS, DICKEY & PIERCE, P.L.C., P.O. BOX 828, BLOOMFIELD HILLS, MI, 48303, US

(73) Assignee: DIGITAL FLOW CO., LTD., Seoul (KR)

(21) Appl. No.: 11/569,443

(22) PCT Filed: May 20, 2005
(86) PCT No.: PCT/KR05/01475

§ 371 Date: Nov. 21, 2006

(30) Foreign Application Priority Data
May 22, 2004 (KR) 10-2004-0036600

(51) Int. Cl. G06F 17/00

(52) U.S. Cl. 707/104.1; 707/E17.009

(57) ABSTRACT

The present invention relates to multimedia music contents service in which sound source and text are synthesized to form one file. In the case where a music file is provided by way of web service by applying DRM being contents protection technology, there is a problem in that a user has to receive sound source contents and text data separately, and cannot compose or machine them. In order to solve this problem, according to the present invention, before DRM is applied, sound source and text are previously composed and are then serviced. According to the present invention, sound source data and text data can be stored in databases, respectively. If requests for a music file are made by way of web service, a corresponding music file is composed and provided by way of web service through DRM. Alternately, sound source and text data can be previously composed and then stored in databases. If requests for a music file are made by way of web service, a corresponding music file is serviced with DRM being applied thereto.

### FIELD

The present invention relates to multimedia music contents service in which sound source and text are synthesized to form one file, and more particularly, to multimedia music contents service method and system thereof, wherein a user can receive a music and text at the same time when receiving download or streaming service of a music file without editing or inserting the text.

### BACKGROUND

Music service through a web provides web streaming or download service. In this service, service is provided in which only music is provided, or in which when music is output from a web browser for a PC through streaming service, a text DB is searched, text is received and buffered, and the text is displayed based on time information while music is played. This method is limited to a PC. In the case of downloaded music files, only sound source (music) is serviced. Thus, a user has to generate one file in which text and sound source are synthesized by manually adjusting music and text using an edit program for a PC, or synthesizing a text and music by searching a text DB that is previously synchronized, and to view the text while listening to downloaded music through a device, such as a MP3 player.

In this case, there is a difficulty in that a user has to work twice due to a difference in favored music among users and in terms of time although a song is synchronized to a text.

Technical Problem

An object of the present invention is to allow an entity who services music to combine a serviced music and text in order to form one file, and a user to receive music and text at the same time upon reception of downloading or streaming service of a music file without inserting or editing the text.

Technical Solution

Recently, in the case of contents that are serviced through the Internet in a web with fee, they are serviced under digital rights management (hereinafter, referred to as “DRM”, which is contents protection technology. In this case, a user cannot arbitrarily add or delete other data to or from data to which DRM is applied. This makes it impossible for a user to insert or mix text information using an edit program in a PC.

For this reason, desired information has to be inserted or mixed into or with original sound data before DRM is applied, and DRM is then added to contents generated thus, which are then serviced.

In the present invention, in order to solve this problem, before DRM is applied, text is synthesized with sound source to produce a file, wherein the text is inserted into music, which is then serviced. One file can be generated by using an information data space that is supported in Codec, such as ID3 tag, or adding text or encrypted information prior and subsequent to sound source data. Alternately, text can be directly inserted into sound source data using a watermarking method.

Meanwhile, if the ID3 tag is employed, a variety of information can be inserted by using 20 kinds of defined fields. A user can also insert necessary information. However, since a user cannot arbitrarily have access to ID3 tag information located at the head or end of a file while playing a file, he or she has to store additional information, which will be used during the play of the file, in a memory before the start of the play. At this time, in the event that information to be used is various and the capacity of a memory that is available in a portable play device is insufficient, a variety of additional information cannot be utilized.

For example, if it is desired to display a song text on a LCD of a portable audio player, text information has to be previously stored in the memory so that it can be displayed on the LCD if the text information exists in the ID3 tag as additional information. Generally, text data corresponding to a song of about 4 minutes occupy a memory capacity of at least 1 to 2 Kbytes. In addition, if a song text is inserted into a frame, only detected text data can be displayed on the LCD although they are not previously stored in the memory. Thus, if a memory is capable of storing data of about one bar, all text of a song can be displayed on the LCD. Further, in the same manner as a case where various images are displayed on a screen while listening to a song, all images need not be stored in the memory at once.

In view of this, in the present invention, a user can obtain additional information in real time during play by inserting additional information into a frame that is repeatedly analyzed in order to reproduce a file. For example, if text information of music is inserted into a frame, a detected text can be displayed on a portable play device in real time during play of the music. If image information is inserted into a frame by means of the watermark method, a user can display a variety of images on the LCD while listening to music.

The present invention proposes a method in which a variety of additional information related to MP3 files can be inserted into frames by means of the watermarking method, and detected. Furthermore, the present invention presents a method wherein the format of a file is not changed due to the insertion of additional information, and no problems are generated during play. Inserted additional information can be detected during play by means of a portable play device that can play MP3 files, as well as a common personal computer, so that it can be utilized as various forms.

According to an embodiment of the present invention, there is provided a multimedia music contents service method, including the steps of storing sound source data in a database, storing text data in a database in synchronization with the sound source data, if requests for a music file are made from a client by way of web service, searching the sound source database and the text database for corresponding sound source data and text data, and synthesizing the text data and the sound source data, applying DRM to one music file in which the text data and the sound source data are synthesized, and servicing the music file to which DRM is applied to the client by way of web service.

Furthermore, according to another embodiment of the present invention, there is provided a multimedia music contents service method, including the steps of previously synthesizing sound source data and text data into one music file, and storing the synthesized music file synchronized to sound source and text in a database, if requests for a music file are made from a client by way of web service, searching the music file in which the sound source and text are synthesized for a corresponding music file, applying DRM to the music file, and servicing the music file to which DRM is applied to the client by way of web service.

### SUMMARY

In order to accomplish the present invention, a multimedia music contents service system, including a sound source data DB that stores sound source data, a text data DB 20 that stores text data synchronized to the sound source data stored in the sound source data DB, a converting module, which searches the sound source data DB for corresponding sound source data if a client terminal makes requests for a predetermined music file by way of web service, searches the text data DB for text data corresponding to the sound source data, and synthesizes the sound source data and the text data to produce one music file in which the sound source and the text are mixed, a DRM module that processes use restriction depending upon contents protection of a music file in which sound source and text are synthesized in the converting module, and a web service server, which requests for a music file from a user client terminal through the Internet, searches corresponding sound source data and text data, controls the converting module, and services the music file processed in the DRM module to the user client terminal through the Internet in a streaming or download mode.

Furthermore, sound source data and text data are previously synchronized and synthesized to produce a file, which is stored in a music file database. The music file database is searched according to requests for a music file, and a searched file is serviced through a DRM module.

### DRAWINGS

FIG. 1 is a view illustrating the construction of a multimedia music contents service system according to the present invention;

FIG. 2 shows the configuration of a frame of an audio file according to the present invention;

FIG. 3 is a flowchart illustrating a process of inserting a sync signal according to the present invention;

FIG. 4 a flowchart illustrating a process of inserting a sync signal according to another embodiment of the present invention;

FIG. 5 is a schematic view showing the configuration of an audio file into which a sync signal is inserted on a frame basis according to another embodiment of the present invention;

FIG. 6 is a view illustrating the construction of a multimedia music contents service system according to another embodiment of the present invention; and

FIG. 7 shows the configuration of a frame for explaining another embodiment of the present invention in which text data are inserted by means of a watermark method.

### DETAILED DESCRIPTION

The present invention will now be described in detail in connection with preferred embodiments with reference to the accompanying drawings.

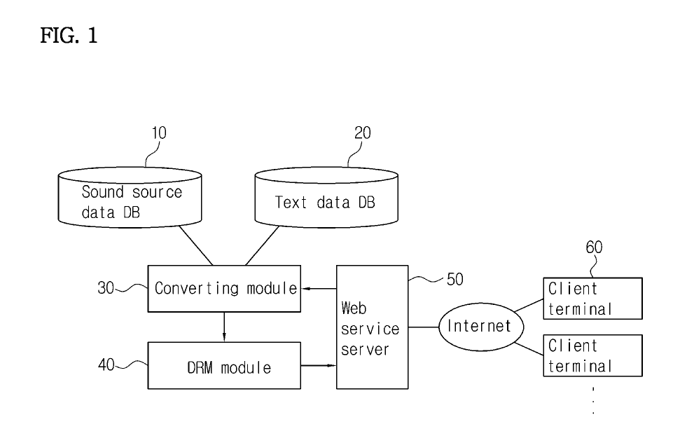

FIG. 1 illustrates the construction of a multimedia music contents service system in which sound source data and text data are composed according to the present invention.

The multimedia music contents service system includes a sound source data DB 10 that stores sound source data, a text data DB 20 that stores text data synchronized to sound source data, which is stored in the sound source data DB 10, a converting module 30, which searches the sound source data DB 10 for corresponding sound source data if requests for a predetermined music file are made by a client terminal 60 through web service, searches the text data DB 20 for text data corresponding to the sound source data, and synthesizes the sound source data and text data to produce one music file wherein the sound source and text are synthesized, a DRM module 40 that processes use restriction according to contents protection of a music file in which sound source and text are synthesized in the converting module 30, and a web service server 50, which receives requests for a music file from a user client terminal 60 through the Internet, searches corresponding sound source data and text data, controls the converting module 30, and services a music file that is processed in the DRM module 40 to the user client terminal 60 in streaming or download mode through the Internet.

At this time, the text data DB 20 can store text data information that is synchronized to sound source data, as well as text data information.

Further, the converting module 30 can generate one file by using an information data space supported in Codec, such as the ID3 tag, or adding text or encrypted information to the end or head of sound source. As an alternate method, text or encrypted information can be directly inserted into sound source data by means of the watermarking method. The DRM module 40 is known in the art, and will not be thus described in detail.

In an embodiment of the present invention, it has been described that the format of a music file is MP3. However, the fact that a method of inserting a sync signal according to the present invention can be applied to music files that are stored according to other audio file formats, such as WMA, AAC and AC3, will be apparent to those skilled in the art.

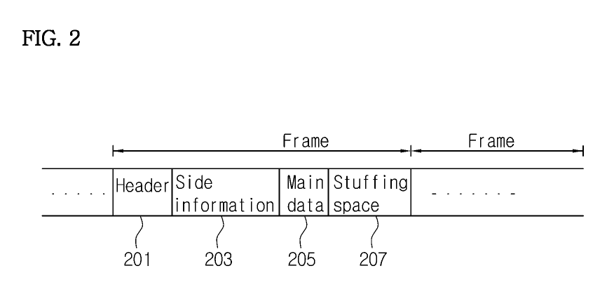

FIG. 2 is a view showing the configuration of a MP3 frame. The configuration of the MP3 frame will now be described with reference to FIG. 2. A MP3 audio file consists of a plurality of consecutive frames. Each of the frames includes a header 201 having 12-bit sync bit, side information 203, main data 205 and a stuffing space 207.

The header 201 and the side information 203 store overall information relating to the configuration of a frame, etc. as well as sync. The main data 205 stores audio contents that are lossless compressed according to the Huffman coding method. The lossless compressed main data 205 are stored on a byte basis. As a result of Huffman coding, redundant bits that never contain audio contents are generated.

These redundant bits are called “stuffing bits” and the portion of stuffing bits is called a “stuffing space”. That is, these bits are an empty space that is never used upon play of music. The stuffing space 207 is a bit for making the size of a frame including the main data 205 on a byte basis. The size of the stuffing space 207 is decided according to the size of the main data 205, which is generated through Huffman coding of audio contents.

As will be described in detail, in the present invention, a sync signal is inserted into a stuffing space using such structural characteristics of a frame.

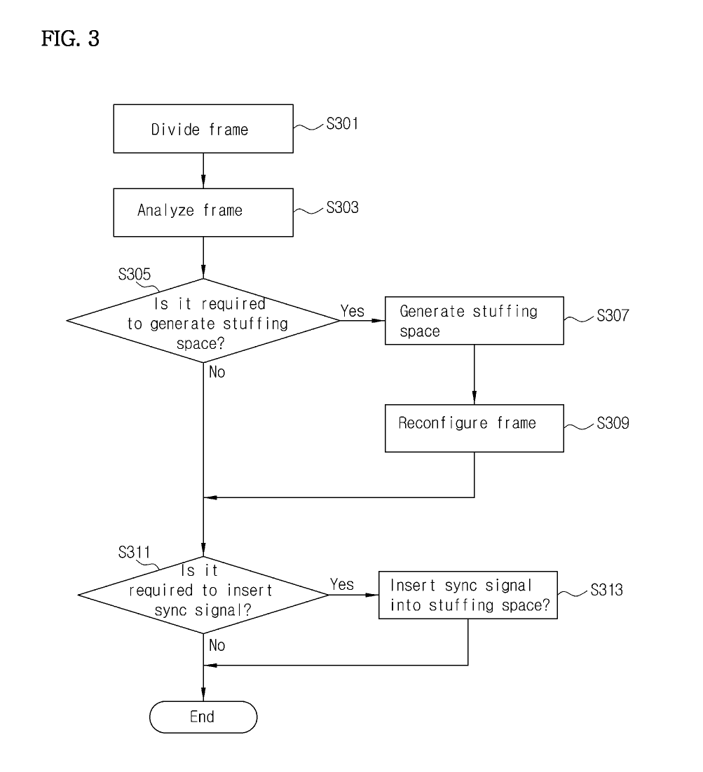

FIG. 3 is a flowchart illustrating a process of inserting a sync signal according to the present invention. Referring to FIG. 3, if a MP3 audio file to be played is selected, it is divided into frames (S301).

Frame analysis is performed on each of the divided frames (S303). In such frame analysis, the header 201 and the side information 203 are analyzed to acquire the start location of the main data 205 and information on the size of the main data 205. The size and location of the stuffing space 207 are then obtained based on the information on the size of the main data 205.

It may be determined that the stuffing space 207 does not exist depending upon the size of the main data 205. Even in this case, if it is determined that a space into which a sync signal will be inserted is needed (S305), a space for the stuffing space 207 can be arbitrarily generated (S307).

At this time, for the purpose of the stuffing space, 1 byte can be newly allocated. Accordingly, frames are re-constructed so that all frames following the stuffing space can shift back as much as 1 byte (S309).

It is then determined whether a sync signal has been inserted into a corresponding frame (S311). Whether the sync signal is inserted can be determined according to information that is previously received from a user. For example, the user can directly input which portion of a text will be output at which time point while playing an audio file using a predetermined input device of a text synchronization apparatus.

It can also be automatically decided as in a case in accordance with the TTS mode that will be described later.

If it has been determined that it is necessary to insert a sync signal, the sync signal is inserted into the stuffing space (S313). The size of the sync signal can be generally greater than the bit number of a stuffing space. Thus, one sync signal is not all inserted into one stuffing space, but at least some of the sync signal can be inserted into one stuffing space. Alternately, one sync signal can be inserted into a plurality of stuffing spaces. In an illustrative embodiment, the stuffing space can include a portion that indicates the existence of a sync signal, and portions that indicate the location of a text and a character number of an output text, as contents of the sync signal. What bits of a sync signal will be inserted into a corresponding frame is decided according to the bit number of a predetermined stuffing space.

If the aforementioned process is repeatedly performed on each of the frames, the sync signal is inserted into an audio file consisting of frames.

That is, the process includes the steps of analyzing a frame of an audio file; detecting the size and location of a stuffing space based on a header and side information obtained through the frame analysis; if the stuffing space does not exist, allocating one byte to generate the stuffing space; determining whether to insert a sync signal into a corresponding frame; and inserting the sync signal into the stuffing space. Further, if the sync signal is not a frame that will be inserted, a step of inserting text, i.e., text data into a corresponding stuffing space can be performed.

Therefore, a sync signal inserted into an audio file is provided so that audio contents and text can be synchronized through the aforementioned construction. Accordingly, when audio contents are played and a text synchronized to the audio contents is output, excessive consumption of resources can be prevented in an audio contents play device.

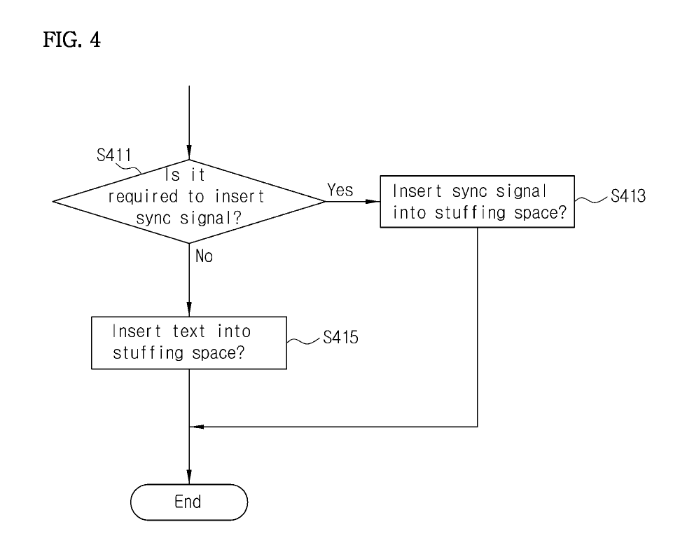

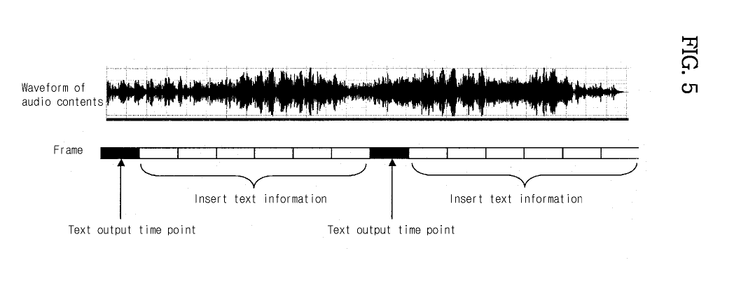

Another embodiment of the present invention will now be described with reference to FIGS. 4 and 5. FIG. 4 a flowchart showing a process of inserting a sync signal according to another embodiment of the present invention.

Though not shown in FIG. 4, steps S301 to S309 of FIG. 3 also exist prior to step S411 of FIG. 4 in the same manner. They will be omitted in order to avoid redundancy.

It is first determined whether a sync signal has to be inserted into a stuffing space (S411).

If it is determined that the sync signal needs not to be inserted, a text is inserted into the stuffing space (S415). The length of a text character string is generally greater than the bit number of a stuffing space. Thus, all of predetermined text character strings are not inserted into one stuffing space, but at least some of the text character strings can be inserted into one stuffing space. That is, one text character string can be inserted into a plurality of stuffing spaces.

FIG. 3 is a flowchart illustrating a sync signal insertion process according to the present invention.

FIG. 5 is a schematic view showing the configuration of an audio file into which a sync signal is inserted on a frame basis according to another embodiment of the present invention. In FIG. 5, the audio file is divided on a frame basis. In each of the frames, a frame corresponding to insertion of text information included text information. A frame corresponding to a text output time point includes a sync signal. However, in the frame corresponding to the insertion of text information, nothing information can be inserted into the stuffing space. This indicates a standby region, as described above. Text information that will be first output is inserted into one or more frames so that a play time point of a frame including a sync signal becomes an output time point where a text inserted into a previous frame is output. After text information to be output is all inserted, it remains in the standby state until the sync signal is inserted. In the standby state, additional information is not inserted into the frame, but stuffing bits existing in each frame are all initialized to “0”.

Thereafter, if the location of a current frame coincides with temporal information where a text will be output, the sync signal is inserted.

Referring back to FIG. 4, if it is determined that the sync signal has to be inserted, the sync signal is inserted into the stuffing space (S413). As described above with reference to FIG. 3, since the size of a sync signal is generally greater than the bit number of a stuffing space, one sync signal can be all inserted into one stuffing space, but at least some of the sync signal can be inserted into one stuffing space. That is, one sync signal can be inserted into a plurality of stuffing spaces. The sync signal inserted into the stuffing space can include only a portion indicating the existence of the sync signal. Upon play of an audio file, information stored in the stuffing space of frames prior to a frame in which the sync signal is detected is a fragment of text information. Thus, if they are synthesized together, a text that will be output to a display in detecting the existence of the sync signal can be obtained.

If the aforementioned process is repeatedly performed on each of the frames, a sync signal and a text corresponding to audio contents can be inserted into an audio file consisting of the frames.

As described above, in the present invention, sound source data (audio contents) and text data (text) are composed to form one music file (audio file) in the converting module 30, and is then serviced through the DRM module 40.

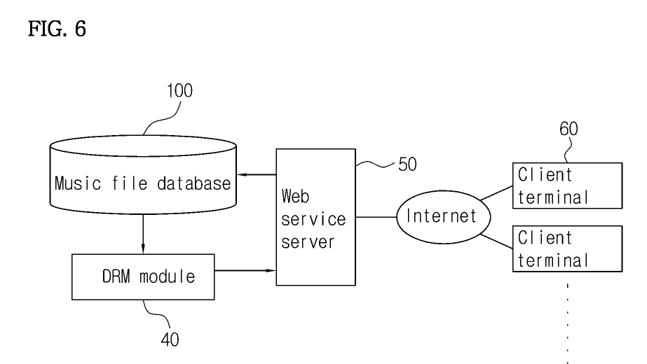

Meanwhile, FIG. 6 shows another embodiment of the present invention. Sound source data and text data are previously composed in the same method as the above described method, and a produced music file is then stored in a music file database 100. If there are requests for a music file from the client terminal 60 through the Internet, the web service server 50 searches the database 100 for the music file. The searched music file undergoes a DRM process in the DRM module 40. The web service server 50 provides the processed music file to the client terminal 60.

Furthermore, the present invention presents a method in which various additional information related to a MP3 file is inserted into a frame according to the watermark mode and is detected, as described above. The present invention also presents a method in which the format of a file is not changed due to the insertion of additional information, and nothing problem is generated during play. A portable play device that can reproduce a MP3 file, as well as a common personal computer, detects inserted additional information during play, and utilizes the detected additional information as various forms.

A file in which additional information is inserted into a frame in a distributed manner can be reproduced without any modification or change of a program in a personal computer and a portable play device. If a file is not played in a reproducible computer or a portable play device after additional information is inserted into a file, programs for various platforms have to be provided in order to reproduce the file. It is impossible actually, and makes users inconvenient.

Therefore, the present invention presents a method in which a file can be normally played in all existing MP3 players, and additional information can be inserted into a frame through watermark technology so that a variety of additional information requested by a user can be detected during play and can be then detected effectively by an apparatus in which limited resources can be used, such as a portable play device.

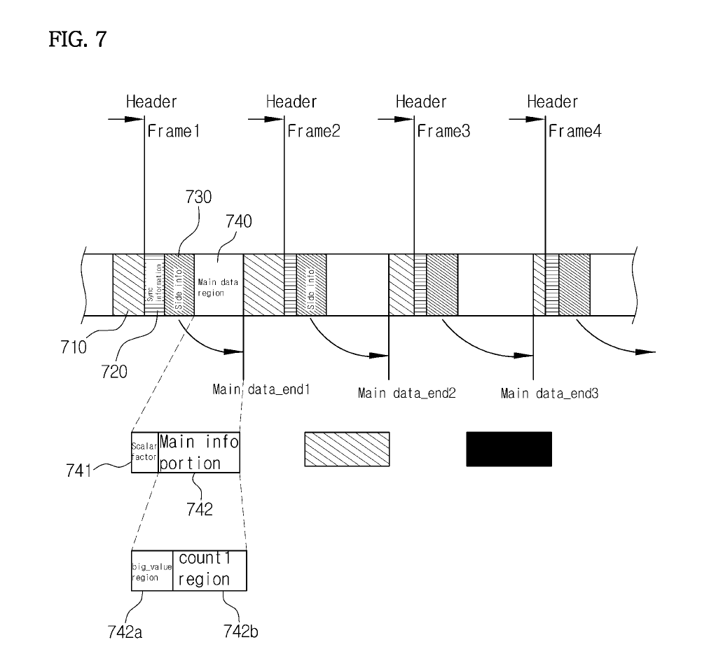

MP3 is a kind of a file format in which several frames are consecutively constructed, as shown in FIG. 7. The frame can be divided into a header 710 that includes sync information 720 for finding out the start point of a frame, side info 730, and a main data region 740 that stores audio compression data. In this case, a portion where information can be hidden is the main data region 740. The data region 740 consists of a scale factor 741, and a main info portion 742 compressed in the Huffman coding method, which is a region where information can be hidden.

At this time, if the configuration of the frame shown in FIGS. 2 and 7 is shown as an actual configuration, the header 710 and the sync information 720 of FIG. 7 are inserted into the header 210 of FIG. 2, the side information 203 of FIG. 2 is the side info 720 of FIG. 7, the main data is the same region, and the stuffing space 207 of FIG. 2 is not shown in FIG. 7. The stuffing space can be included in the audio file, but not included therein. If description is given on the basis of FIG. 2, it has been described that one byte is generated and added when a stuffing space does not exist. In FIG. 7, however, text data are inserted into the main data region in watermark mode regardless of whether the stuffing space exists or not.

The scale factor region 741 is a region that stores values related to quantization for each sub-band of audio. The region exist one by one every channel of each frame except for a special case. The special case refers to when no data are allocated to the scale factor. Since data of this region affect the sound quality, some data may not be inserted. If the degree of variations is small, however, information can be hidden in the degree that a man does not recognize data.

A main info portion 742 is divided into a big_value region 742a and a count1 region 742b. Since change of the big_value region 742a has a great influence upon the sound quality, information has to be inserted using the count1 region 742b. When information is inserted into the count1 region 742b, the length of the Huffman code should not be changed. If the size of a frame is changed, lots of time is taken to insert a watermark since the whole MP3 file has to be packaged again.

In the watermark, information of 1 byte is allocated to each frame. Data can be inserted using one of the scale factor and the count1 region.

### INDUSTRIAL APPLICABILITY

As described above in detail, according to the present invention, sound source data and text data are previously stored in databases. If there are requests for a music file through a web, the sound source data and the text data are synthesized to produce one music file. Or, sound source data and text data are previously synthesized and stored in databases as a music file. Upon service, the music file undergoes a DRM process and is then provided. Therefore, there is an effect in that a user can receive a music file where music and text are synthesized, and then play text data through synchronization of music and text upon play.

Therefore, in the present invention, in the case where DRM is applied, sound source and text data are previously mixed, and DRM is then applied. This solves a problem that a user cannot add or delete a file after DRM is applied. Accordingly, there is an effect in that sound source and text can be serviced as one music file contents.

1. A multimedia music contents service method, comprising the steps of:
storing sound source data in a database;
storing text data in a database in synchronization with the sound source data;
if requests for a music file are made from a client by way of web service, searching the sound source database and the text database for corresponding sound source data and text data, and synthesizing the text data and the sound source data;
applying DRM to one music file in which the text data and the sound source data are synthesized; and
servicing the music file to which DRM is applied to the client by way of web service.

2. The multimedia music contents service method as claimed in claim 1, wherein the step of synthesizing the text data and the sound source data includes generating one file by adding text or encrypted information to an information data space and directly inserting the text data.

3. The multimedia music contents service method as claimed in claim 1, wherein the step of synthesizing the text data and the sound source data includes inserting the text data in watermark mode using one of a scale factor and a count1 region, which exist within a main data region, among each frame of an audio file.

4. The multimedia music contents service method as claimed in claim 1, wherein the step of synthesizing the text data and the sound source data includes the steps of:
analyzing frames of an audio file;
detecting the size and location of a stuffing space based on a header and side information detected through the frame analysis;
if the stuffing space does not exist, allocating one byte to generate the stuffing space;
determining whether a sync signal has to be inserted into a corresponding frame, and inserting the sync signal into the stuffing space in a divided manner; and
if it is a frame into which the sync signal needs not to be inserted, inserting a text corresponding to the text data into a corresponding stuffing space in a divided manner.

5. A multimedia music contents service method, comprising the steps of:
previously synthesizing sound source data and text data into one music file, and storing the synthesized music file synchronized to sound source and text in a database;
if requests for a music file are made from a client by way of web service, searching the music file in which the sound source and text are synthesized for a corresponding music file;
applying DRM to the music file; and
servicing the music file to which DRM is applied to the client by way of web service,
wherein the step of synthesizing the sound source data and the text data includes the steps of:
analyzing frames of an audio file;
detecting the size and location of a stuffing space based on a header and side information detected through the frame analysis;
if the stuffing space does not exist, allocating one byte to generate the stuffing space;
determining whether a sync signal has to be inserted into a corresponding frame, and inserting the sync signal into the stuffing space in a divided manner; and
if it is a frame into which the sync signal needs not to be inserted, inserting a text corresponding to the text data into a corresponding stuffing space in a divided manner.

6. A multimedia music contents service method, comprising the steps of:
previously synthesizing sound source data and text data into one music file, and storing the synthesized music file synchronized to sound source and text in a database;
if requests for a music file are made from a client by way of web service, searching the music file in which the sound source and text are synthesized for a corresponding music file;
applying DRM to the music file; and
servicing the music file to which DRM is applied to the client by way of web service,
wherein the step of synthesizing the sound source data and the text data includes inserting the text data in watermark mode by using one of a scale factor and a count1 region that exist within a main data region, among each frame of an audio file.

7. A multimedia music contents service system, comprising:
a sound source data that stores sound source data;
a text data that stores text data synchronized to the sound source data stored in the sound source data;
a converting module, which searches the sound source data for corresponding sound source data if a client terminal makes requests for a predetermined music file by way of web service, searches the text data for text data corresponding to the sound source data, and synthesizes the sound source data and the text data to produce one music file in which the sound source and the text are synthesized;
a DRM module that processes use restriction according to contents protection of a music file in which sound source and text are synthesized in the converting module; and
a web service server, which requests for a music file from a user client terminal through the Internet, searches corresponding sound source data and text data, controls the converting module, and services the music file processed in the DRM module to the user client terminal through the Internet in a streaming or download mode.

8. The multimedia music contents service system as claimed in claim 7, wherein the converting module inserts the text data in watermark mode using one of a scale factor and a count1 region that exist within a main data region, among each frame of an audio file.

9. A multimedia music contents service system, comprising:
a music file database that stores sound source data and text data, which are previously synthesized, and a file in which sound source and text are synthesized in synchronization with each other;
a DRM module that searches the music file database for a corresponding music file if a user client terminal makes requests for a predetermined music file by way of web service, and applies DRM for use restriction according to contents protection; and
a web service server, which receives requests for a music file from the user client terminal through the Internet, searches a corresponding sound source file, controls a DRM process, and provides the music file processed in the DRM module to the user client terminal through the Internet in streaming or download mode.

10. The multimedia music contents service system as claimed in claim 9, wherein the database stores text data that are inserted in watermark mode using one of a scale factor and a count1 region that exist within a main data region, among each frame of a sound source data file.
